(19) United States
(12) Patent Application Publication
(10) Pub. No.: US 2025/0369682 A1
(43) Pub. Date: Dec. 4, 2025

(54) HINGE FOR REFRIGERATED CABINETS

(71) Applicant: SNWC, Inc., New York, NY (US)

(72) Inventor: Sam Naparstek, New York, NY (US)

(21) Appl. No.: 18/731,081

(22) Filed: May 31, 2024

(51) Int. Cl. F25D 23/02; E05D 3/06

(52) U.S. Cl. CPC F25D 23/028; E05D 3/06; E05Y 2900/31; F25D 2323/024

(57) ABSTRACT

A hinge for a refrigerated cabinet includes a hinge support mounted on the refrigerated cabinet, a linkage mechanism, and a hinge bracket. The hinge support includes a planar portion in which one or more opened coupling holes are defined, a linkage mechanism including at least one pivot arm. The linkage mechanism includes a proximal end and a distal end. The linkage mechanism is configured to rotatably attach to the hinge support at the distal end. The hinge bracket is configured to rotatably attach to the proximal end of the linkage mechanism. The linkage mechanism serves as a rotation shaft of a mounted door articulating out of the refrigerated cabinet. The hinge support and the hinge bracket are configured to fold on top of each other in a closed configuration.

### TECHNICAL FIELD

The present disclosure relates to a hinge for a refrigerated cabinet. More particularly, implementations of the present disclosure are directed to hinges that increase interior capacity of cabinets, supporting ultra-thin doors that are flush, recessed or otherwise inset mounted into a cabinet or within the refrigerator cabinet itself.

### BACKGROUND

Hermetical closure of refrigerated cabinets is crucial for controlling internal temperature and optimizing energy efficiency. The closure of refrigerated cabinets can be affected by multiple features of the of refrigerated cabinets including door and hinge characteristics. In general, doors mounted on the refrigerated cabinet can be opened and closed through a hinge facilitated rotation. For example, the door can be rotatably coupled to a main body defining a storage space by using a hinge. In some cases, a hinge can include a hinge plate fixed to a main body and a hinge pin connecting the hinge plate to a door to serve as a rotation shaft of the door. In some cases, the hinge pin limits the rotation shaft of the door and can cause the edge of the door to hit the housing of the refrigerated cabinet or a wall/adjacent cabinetry.

### SUMMARY

Implementations of the present disclosure are directed to a hinge for a refrigerated cabinet. More particularly, implementations of the present disclosure are directed to hinges that increase interior capacity of cabinets, supporting ultra-thin doors.

In some implementations, a refrigerated cabinet hinge includes: a hinge support mounted on the refrigerated cabinet, the hinge support including a planar portion in which one or more opened coupling holes are defined, a linkage mechanism including at least one pivot arm, the linkage mechanism including a proximal end and a distal end, the linkage mechanism configured to rotatably attach to the hinge support at the distal end, and a hinge bracket configured to rotatably attach to the proximal end of the linkage mechanism, the linkage mechanism serving as a rotation shaft of a mounted door articulating out of the refrigerated cabinet, wherein the hinge support and the hinge bracket are configured to fold on top of each other in a closed configuration.

In other implementations, a refrigerated cabinet hinge includes: a hinge support horizontally mounted on a surface of the refrigerated cabinet, the hinge support including a planar portion in which one or more opened coupling holes are defined, a linkage mechanism including at least one pivot arm, the linkage mechanism including a proximal end and a distal end, the linkage mechanism is configured to rotatably attach to the hinge support at the distal end, and a hinge bracket configured to rotatably attach to the proximal end of the linkage mechanism, the linkage mechanism serving as a rotation shaft of a mounted door articulating out of the refrigerated cabinet, wherein the hinge support and the hinge bracket are configured to fold on top of each other in a closed configuration.

In other implementations, a refrigerated cabinet hinge includes: a hinge support mounted on a bottom vertical edge of the refrigerated cabinet, the hinge support including a bent structure including a vertical portion and a horizontal portion, a linkage mechanism including at least one pivot arm, the linkage mechanism including a proximal end and a distal end, the linkage mechanism configured to rotatably attach to the hinge support at the distal end, and a hinge bracket configured to rotatably attach to the proximal end of the linkage mechanism, the hinge bracket including a hinge pin that serves as a rotation shaft of a mounted door articulating out of the refrigerated cabinet, wherein the horizontal portion of the hinge support and the hinge bracket fold on top of each other in a closed configuration.

The foregoing and other implementations can each optionally include one or more of the following features, alone or in combination. In particular, implementations can include all of the following features:

In one aspect, combinable with any of the previous aspects, the mounted door includes a panel and a frame. The mounted door has a thickness of approximately 10 mm to 50 mm. The mounted door articulates within or wraps around the refrigerated cabinet, when the refrigerated cabinet is closed, the door being flush fitted within an exterior housing of the refrigerated cabinet or adjacent external cabinetry or surfaces. The mounted door articulates out when the mounted door is opened. The mounted door articulates around the refrigerated cabinet when the mounted door is opened. The mounted door is flush fitted with the refrigerated cabinet when the mounted door is closed. The at least one pivot arm includes a pair of articulating bars. The hinge bracket movement relative to the hinge support is limited to a stable configuration, wherein in the stable configuration the refrigerated cabinet is opened (up to a set angle) without a toppling risk. The at least one pivot arm includes a substantially (approximatively) flat surface. The hinge support is mounted on a surface of the refrigerated cabinet. The hinge support is at least partially embedded into the body of the refrigerated cabinet. The hinge could include Polyvinyl chloride (PVC), thermoplastic, aluminum, stainless steel, other suitable non-oxidizable metals, metal alloys, or other synthetic polymers.

Implementations according to this aspect can include one or more of the following advantages. The described implementation provides an efficient hinge support coupled to a refrigerated cabinet. The hinge can provide heavy duty support of articulating doors. The hinge can facilitate an increase of an interior capacity of the refrigerated cabinet. The hinge can facilitate flush fitting of the mounted doors to the cabinet body, providing an efficient thermal seal. The hinge can support ultra-thin doors that articulate, without requiring significant mounting brackets and without requiring for a support to be bored into the body of the refrigerated cabinet.

The details of one or more implementations of the subject matter of the specification are set forth in the accompanying drawings and the description below. Other features, aspects, and advantages of the subject matter will become apparent from the description, the drawings, and the claims.

### BRIEF DESCRIPTION OF THE DRAWINGS

The implementations will be described in detail with reference to the following drawings.

FIG. 1A is a perspective view showing an example refrigerated cabinet having a mounting structure of a refrigerated cabinet hinge.

FIG. 1B is another perspective view showing an example refrigerated cabinet having a mounting structure of a refrigerated cabinet hinge.

FIG. 1C is another perspective view showing an example door of a refrigerated cabinet having a mounting structure of a refrigerated cabinet hinge.

FIG. 2 is a perspective view illustrating an assembled state of an example refrigerated cabinet hinge.

FIG. 3A is a top view showing the example refrigerated cabinet hinge of FIG. 2, in a folded configuration.

FIG. 3B is a top view showing the example refrigerated cabinet hinge in a partly opened configuration.

FIG. 3C is a top view showing the example refrigerated cabinet hinge in a fully opened configuration.

FIG. 3D is a bottom view showing the example refrigerated cabinet hinge in a folded configuration.

FIG. 3E is a bottom view showing the example refrigerated cabinet hinge in a partly opened configuration.

FIG. 3F is a bottom view showing the example refrigerated cabinet hinge in a fully opened configuration.

FIG. 4 is a perspective view illustrating an exploded state of another example refrigerated cabinet hinge.

FIG. 5A is a top view showing the example refrigerated cabinet hinge of FIG. 4, in a folded configuration.

FIG. 5B is a top view showing the example refrigerated cabinet hinge in a partly opened configuration.

FIG. 5C is a top view showing the example refrigerated cabinet hinge in a fully opened configuration.

FIG. 5D is a bottom view showing the example refrigerated cabinet hinge in a folded configuration.

FIG. 5E is a bottom view showing the example refrigerated cabinet hinge in a partly opened configuration.

FIG. 5F is a bottom view showing the example refrigerated cabinet hinge in a fully opened configuration.

### DETAILED DESCRIPTION

The present disclosure relates to a hinge for a refrigerated cabinet. More particularly, implementations of the present disclosure are directed to hinges that increase interior capacity of cabinets, supporting ultra-thin doors. The hinge includes a hinge support, a linkage mechanism, and a hinge bracket. The hinge support is coupled to the refrigerated cabinet, such that it increases an interior capacity of the refrigerated cabinet. The linkage mechanism includes one or two pivot arms. The linkage mechanism includes a proximal end and a distal end. The linkage mechanism is rotatably attached to the hinge support at the distal end. The hinge bracket is rotatably attached to the proximal end of the linkage mechanism. The linkage mechanism serves as a rotation shaft of a mounted door articulating out of the refrigerated cabinet. The hinge support and the hinge bracket are configured to fold on top of each other in a closed configuration, facilitating the mounted door to be flush fitted with the refrigerated cabinet or adjacent cabinets or surfaces that are not part of the refrigerated cabinet, when the mounted door is closed.

For convenience of description and understanding of a refrigerated cabinet according to an implementation, although a refrigerated cabinet having a single door coupled by the hinges to a side, top or inside of the refrigerated cabinet body is described as an example, the present disclosure is not limited thereto. For example, the current implementation can be applied to all types of refrigerated (or non-refrigerated) cabinets in which multiple (e.g., two or more) doors are rotatably mounted using the described hinges.

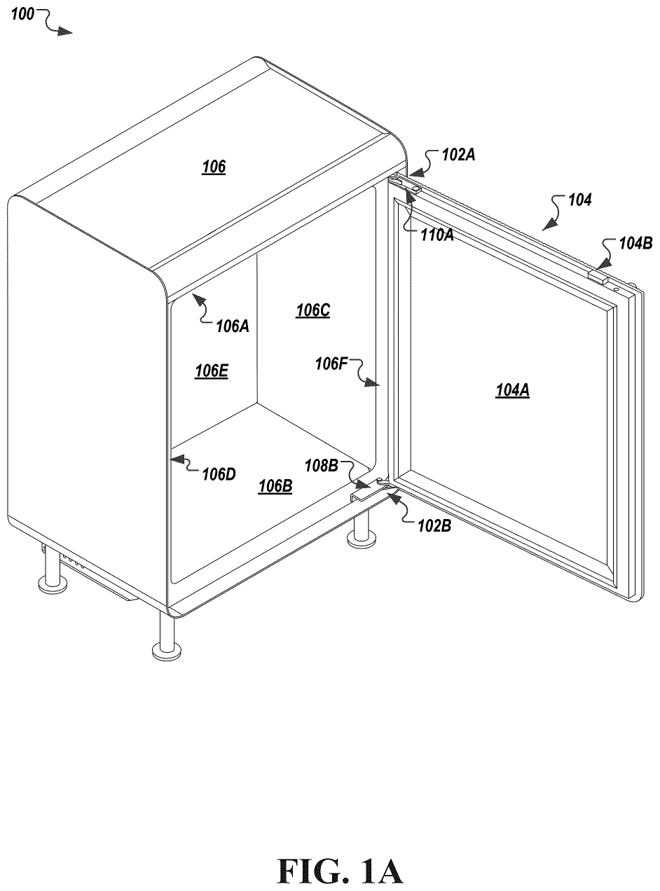

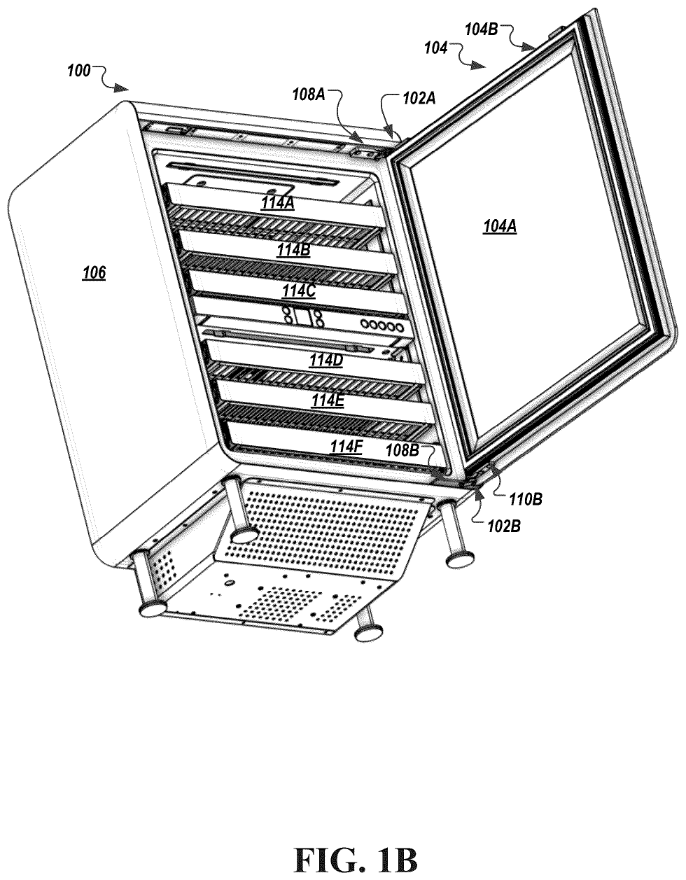

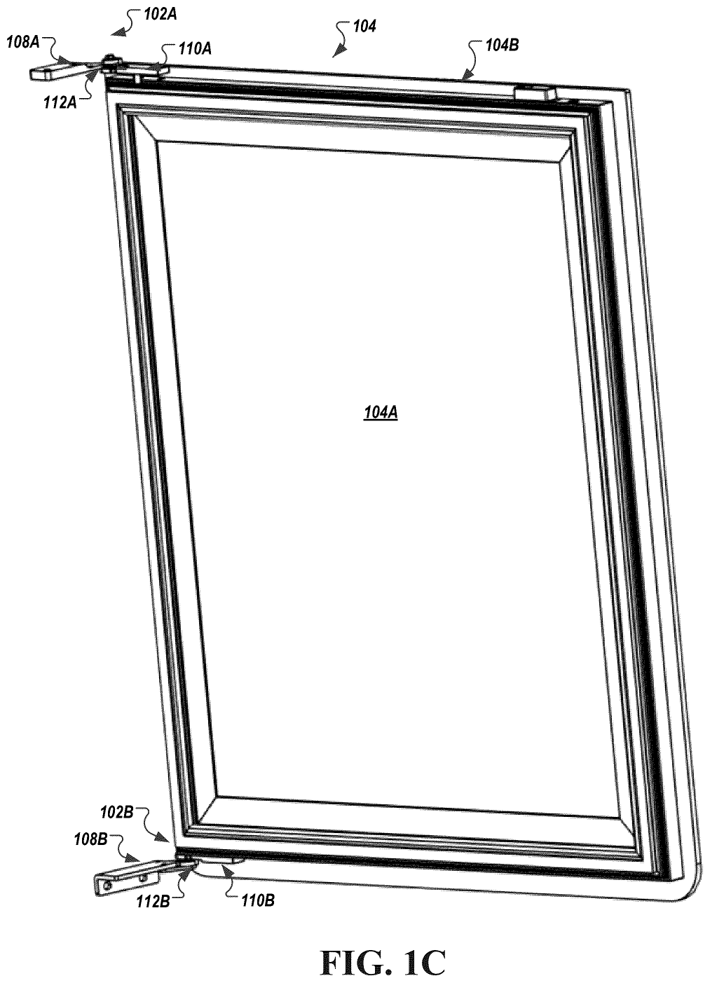

FIGS. 1A and 1B are perspective views showing an example refrigerated cabinet 100 having a mounting structure of one or more hinges 102A, 102B. The refrigerated cabinet 100 according to an implementation includes a door 104 and a cabinet body 106. The cabinet body 106 defines a storage space and the door 104 is disposed on a front surface of the cabinet body 106 to open and close the storage space articulating out, being supported by the one or more hinges 102A, 102B.

The door 104 can include a panel 104A supported by a frame 104B. The door 104 can provide thermal insulation, both the panel 104A and the frame 104B including thermal insulating features. For example, the panel 104A can include at least one insulating glazing component including at least two transparent sheets joined by a spacer frame. The sheets can include thermally strengthened glass or laminated glass. The spacer frame maintains the sheets at a particular distance from each other. The internal space between the sheets includes a heat insulating gas (e.g., Argon or Krypton). The frame 104B can extend along a sealed horizontal edge and a sealed vertical edge of the at least two glass sheets of the panel 104A or a frame and there is at least one insulating space between the at least two glass sheets. The door 104 can include a layer reflecting infrared radiation to improve the thermal insulation performance of the glazed elements. The frame 104B can be constructed from a thermal plastics extrusion, providing thermal insulation for the storage space within the cabinet body 106. In some implementations, any of the panel 104A and the frame 104B are made of any of steel, wood, glass, or any other door material. The mounted door can have a thickness of approximately 10 mm to 50 mm. An outer appearance of the refrigerated cabinet 100 can be defined by the cabinet body 106 and the door 104, the one or more hinges 102A, 102B being hidden within the example refrigerated cabinet 100, when the door 104 is closed. In some implementations, the door 104 can be mounted on the outside of the refrigerated cabinet 100. In some implementations, the cabinet body 106 can be enclosed within an outer cabinet (e.g., custom built cabinetry or multiple refrigerated cabinets 100 can be placed adjacent to each other within the outer cabinet) and the one or more hinges 102A, 102B are configured to facilitate the door 104 to open within the enclosed space of the outer cabinet. In some implementations, the door 104 can be single molded or shaped as a single piece, without a distinction between the panel 104A and the frame 104B.

The storage space within the cabinet body 106 can be defined by an inner top surface 106A, an inner bottom surface 106B, side surfaces 106C, 106D, and a back surface 106E. In some implementations a portion of the top hinge 102A (e.g., a hinge support 108A, as shown in FIGS. 1B, 1C, 2, and 3A-3F) can be coupled to a top portion of the storage space within the cabinet body 106, such as the inner top surface 106A or can be embedded within an inner top wall of the cabinet body 106A. For example, the hinge support 108A can be horizontally mounted on the inner top surface 106A of the refrigerated cabinet body 106. A second portion of the top hinge 102A (e.g., a hinge bracket 110A, as shown in FIGS. 1A, 1C, 2, and 3A-3F) can be coupled to a top portion of the frame 104B of the door 104, such as a top surface of the frame 104B or can be embedded within a top wall of the frame 104B. In some implementations a first portion of the bottom hinge 102B (e.g., a hinge support 108B, as shown in FIGS. 1A, 1C, 2, and 3A-3F) can be coupled to a bottom portion of the storage space within the cabinet body 106, such as the inner bottom surface 106B or can be embedded within an inner bottom wall of the cabinet body 106. A second portion of the bottom hinge 102A (e.g., a hinge bracket 110B, as shown in FIGS. 1A, 1B, 1C, 2, and 3A-3F) can be coupled to a bottom portion of the frame 104B of the door 104, such as a bottom surface of the frame 104B or can be embedded within a bottom wall of the frame 104B or of the door 104. In some implementation, the refrigerated cabinet hinges 102A, 102B can be attached to the front surface of the inner cabinet (e.g., the vertical front surface 106F shown in FIG. 1A).

As shown in the example implementation of FIG. 1B, multiple shelves and/or drawers 114A-114F can be disposed inside the refrigerating storage space within the cabinet body 106. In some implementations, the one or more hinges 102A, 102B can limit the rotation of the door 104 to prevent the inner surface of the door 104 from colliding into any of the shelves and/or drawers 114A-114F. In some implementations, the frame 104B of the door 104 can include an inner rim that extends inward, acting as a door stopper in response to contacting any of the shelves and/or drawers 114A-114F. The frame 104B (e.g., the inner rim) of the door 104 can limit the inward rotation of the door 104, while preventing the panel 104A from colliding into or contacting any of the shelves and/or drawers 114A-114F.

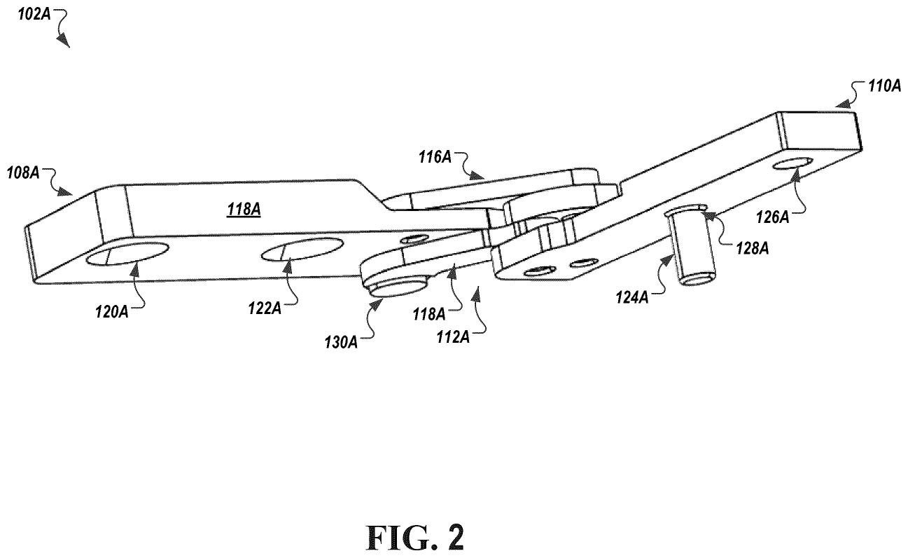

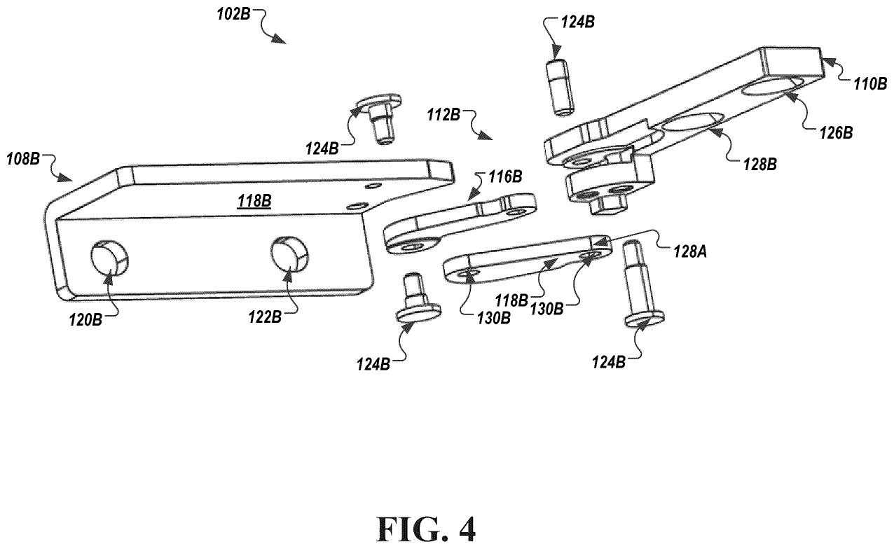

FIG. 1C is another perspective view showing the example door 104 of the refrigerated cabinet 100 having a mounting structure including a pair of refrigerated cabinet hinges 102A, 102B. As shown in FIG. 1C, the hinge brackets 110A, 110B of the pair of refrigerated cabinet hinges 102A, 102B are attached to the frame 104B of the door 104 and to a respective linkage mechanism 112A, 112B. The features of the linkage mechanism 112A of the top hinge 102A are described in further details with reference to FIG. 2 and the features of the linkage mechanism 112B of the bottom hinge 102B are described in further details with reference to FIG. 4.

FIG. 2 is a perspective view illustrating an assembled state of an example (top) refrigerated cabinet hinge 102A. The hinge 102A can include the hinge support 108A, the hinge bracket 110A, and the linkage mechanism 112A. The hinge support 108A can be a cabinet front coupler. The hinge support 108A can include a planar portion. The planar portion facilitates horizontal mounting on a surface of the refrigerated cabinet body 106, as described with reference to FIGS. 1A-1C. The hinge support 108A (e.g., the planar portion of the hinge support 108A) can include one or more (e.g., a pair of) opened coupling holes 120A, 122A (e.g., a main fastening hole 120A and a sub fastening hole 122A). A fastening member 124A can be fastened to the main fastening hole 120A and the sub fastening hole 122A to allow the hinge support 102A to be fixedly mounted on a horizontal or vertical surface of the cabinet body 106. In some implementations, the fastening member 124A can be an independent part couplable to the hinge support 108A and the hinge bracket 110A. The hinge support 108A can be attached to a side wall of the refrigerated cabinet body 106. The fastening member 124A can pass through each of the main fastening hole 120A and the sub fastening hole 122A to be fastened to the cabinet body 106.

The hinge bracket 110A can be a door coupler. The hinge bracket 110A is rotatably attached to the proximal end of the linkage mechanism 112A. The hinge bracket 110A can include a planar portion. The planar portion facilitates horizontal mounting on a surface of the door frame 104B or the door directly. The planar portion can have a width equal to or smaller than the surface of the door frame 104B, to which it is being mounted, as described with reference to FIGS. 1A-1C. The hinge bracket 110A (e.g., the planar portion of the hinge bracket 110A) can include opened coupling holes 126A, 128A (e.g., a main fastening hole 126A and a sub fastening hole 128A). A fastening member 124A can be fastened to the main fastening hole 126A and the sub fastening hole 128A to allow the hinge bracket 110A to be fixedly mounted on the surface of the door frame 104B. The fastening member 124A can pass through each of the main fastening hole 126A and the sub fastening hole 128A to be fastened to the door frame 104B.

The example linkage mechanism 112A includes at least one pivot arm (e.g., two pivot arms 116A, 118A). The linkage mechanism 112A includes a proximal end and a distal end. The linkage mechanism is rotatably attached to the hinge support 108A at the distal end. The pivot arms 116A, 118A can be bar links or flanges with rounded ends facilitating rotation of the pivot arms 116A within a recessed portion of the hinge support 108A and the hinge bracket 110A. The pivot arms 116A, 118A can have an outer circumference that is molded to be rounded by press processing, injection molding, computer numerical control cutting or other methods. The pivot arms 116A, 118A can have multiple fastening holes and/or coupling holes 130A for rotatably coupling to the hinge support 108A and the hinge bracket 110A. The linkage mechanism 112A can serve as a rotation shaft of a mounted door 104 articulating out of the refrigerated cabinet body 106 or out of cabinets or adjacent surfaces. The fastening/coupling holes 120A, 122A, 126A, 128A, 130A can be defined in one at a predetermined distance to maximize the support for the mounted door 104 and for controlling the articulation of the mounted door 104. Another advantage of the hinge 102A is that it prevents toppling the refrigerated cabinet 100, when the mounted door 104 is fully opened to a set angle that is below a threshold at which weight redistribution (set for an empty refrigerated cabinet but including wall bracket attachments) can trigger a toppling hazard.

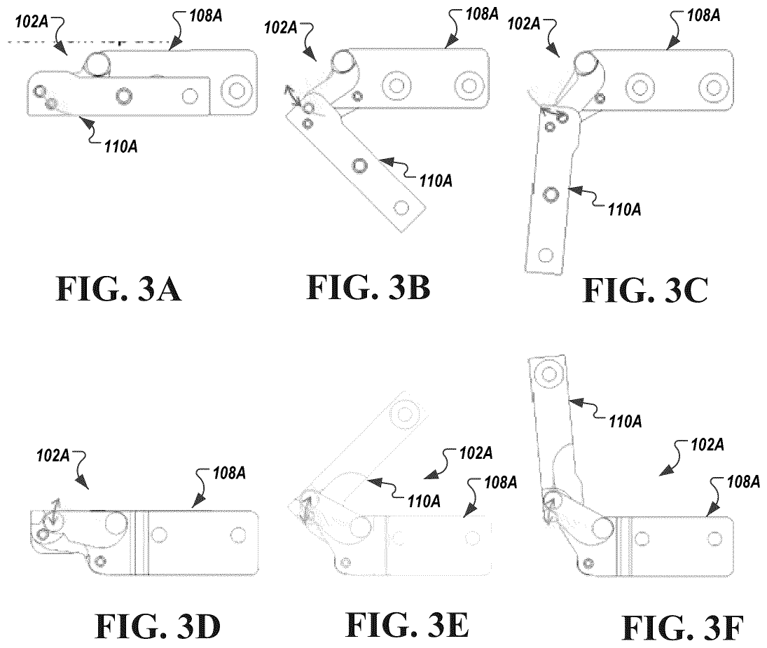

FIGS. 3A-3F are views of the example refrigerated cabinet hinge 102A, described with reference to FIG. 2. The example refrigerated cabinet hinge 102A is illustrated in closed (FIGS. 3A and 3D), partly folded (FIGS. 3B and 3E), and opened configurations (FIGS. 3C and 3F). FIGS. 3A-3F illustrate that the hinge support 108A and the hinge bracket 110A are configured to fold on top of each other in a closed (FIGS. 3A and 3D) configuration. The hinge support 108A and the hinge bracket 110A can be provided as durable, non-oxidizable plates having a predetermined folded thickness (e.g., smaller than or approximately equal to a gap between the door frame 104B and the refrigerated cabinet body 106). In some implementations, the hinge support 108A and the hinge bracket 110A can vary in thickness according to a weight of the door 104.

FIG. 4 is a perspective view illustrating an exploded state of another example refrigerated cabinet hinge 102B. The hinge 102B can include the hinge support 108B, the hinge bracket 110B, and the linkage mechanism 112B. The hinge support 108B can be a cabinet front coupler. The hinge support 108B can include a bent (e.g., L-shaped) structure including a vertical portion and a horizontal portion. The vertical portion of the hinge support 108B facilitates mounting on a surface of the refrigerated cabinet body 106, as described with reference to FIGS. 1A-1C. The horizontal portion of the hinge support 108B facilitates coupling to the linkage mechanism 112B. The hinge support 108B (e.g., the vertical portion and the horizontal portion of the hinge support 108B) can include opened coupling holes 120B, 122B (e.g., a main fastening hole 120B and a sub fastening hole 122B). A fastening member 124B can be fastened to the main fastening hole 120B and the sub fastening hole 122B to allow the hinge support 102B to be fixedly mounted on a horizontal or vertical surface of the cabinet body 106. In some implementations, the hinge support 108B can be attached to a side wall of the refrigerated cabinet body 106. The fastening member 124B can pass through each of the main fastening hole 120B and the sub fastening hole 122B to be fastened to the cabinet body 106.

The hinge bracket 110B can be a door coupler. The hinge bracket 110B is rotatably attached to the proximal end of the linkage mechanism 112B. The hinge bracket 110B can include a planar portion. The planar portion facilitates horizontal mounting on a surface of the door frame 104B, having a width equal to or smaller than the surface of the door frame 104B, to which it is being mounted, as described with reference to FIGS. 1A-1C. The hinge bracket 110B (e.g., the planar portion of the hinge bracket 110B) can include opened coupling holes 126B, 128B (e.g., a main fastening hole 126B and a sub fastening hole 128B). A fastening member 124B can be fastened to the main fastening hole 126B and the sub fastening hole 128B to allow the hinge bracket 110B to be fixedly mounted on the surface of the door frame 104B. The fastening member 124B can pass through each of the main fastening hole 126B and the sub fastening hole 128B to be fastened to the door frame 104B.

In some implementations, an end of the one side of the hinge support 108A and the hinge bracket 110A, in which the main fastening holes 120B, 126B are defined to be rounded along the configuration of each of the main fastening holes 120B, 126B. The main fastening holes 120B, 126B can have an outlet having an inner diameter matching and outer diameter of the fastening member 124B. The fastening member 124B can include portions of different outer diameters, corresponding to the holes of the respective coupling components (e.g., the hinge support 108B, the hinge bracket 110B and linkage mechanism 112B).

The linkage mechanism 112B includes at least one pivot arm (e.g., two pivot arms 116A, 118A). The linkage mechanism 112B includes a proximal end and a distal end. The linkage mechanism is rotatably attached to the hinge support 108B at the distal end. The pivot arms 116A, 118A can be bar links or flanges with rounded ends facilitating rotation of the pivot arms 116A within a recessed portion of the hinge support 108B and of the hinge bracket 110B. The pivot arms 116A, 118A can have an outer circumference that is molded to be rounded by press processing. The pivot arms 116A, 118A can have multiple fastening holes and/or coupling holes 130B for rotatably coupling to the hinge support 108B and the hinge bracket 110B. The linkage mechanism 112B can serve as a rotation shaft of a mounted door 104 articulating out of the refrigerated cabinet body 106. The fastening/coupling holes 120B, 122B, 126B, 128B, 130B can be defined in one at a predetermined distance to maximize the support for the mounted door 104 and for controlling the articulation of the mounted door 104. Another advantage of the hinge 102B is that it prevents toppling the refrigerated cabinet 100, when the mounted door 104 is fully opened to a set angle. In some implementations, the mounted door 104 can articulate around, such as articulating within (e.g., collapsing within the vertical surface 106F of the refrigerated cabinet body 106) and articulating out without or with external constraints (e.g., outer cabinetry).

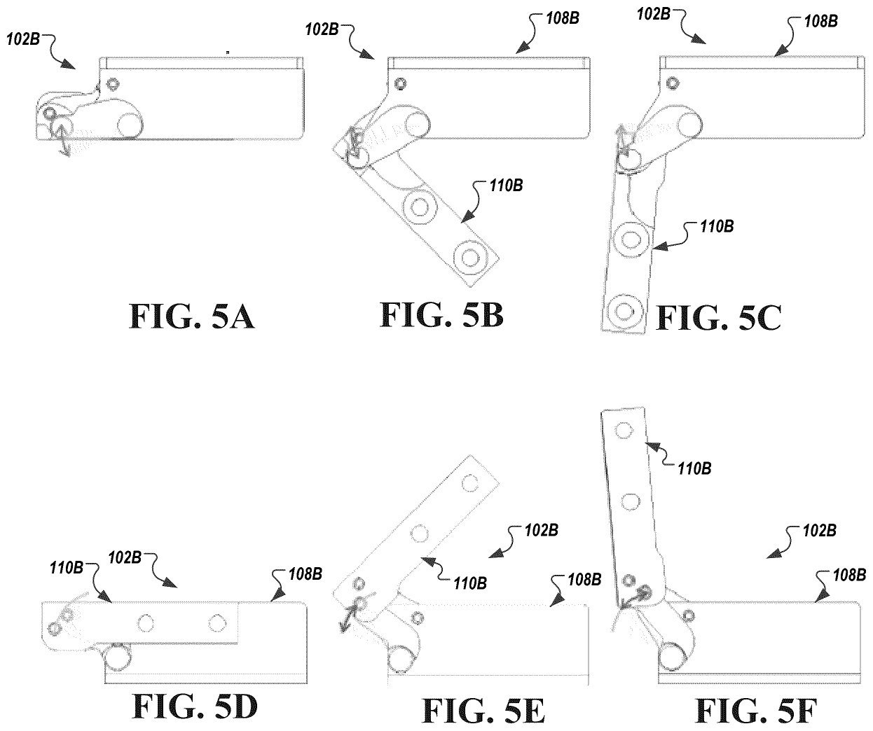

The exploded components of the example refrigerated cabinet hinge 102B (e.g., the hinge support 108B, the hinge bracket 110B, and the linkage mechanism 112B) can be manufactured individually and assembled using an assembly process of pressing and fixing hinge support 108B and the hinge bracket 110B to the linkage mechanism 112B. In the state where the hinge support 108B, the hinge bracket 110B, and the linkage mechanism 112B are completely fixed to each other, the hinge support 108B, and the hinge bracket 110B can be disposed perpendicular to each other, as shown in (FIGS. 5C and 5F). The portion at which outer surfaces of the hinge support 108B, the hinge bracket 110B, and the linkage mechanism 112B contact each other can be rounded or inclined to maximize mobility and decrease friction. In the state where the example refrigerated cabinet hinge 102B is completely assembled, surface treatment, such plating or printing can be performed on surfaces of the hinge support 108B, the hinge bracket 110B, and the linkage mechanism 112B.

FIGS. 5A-5F are views of the example refrigerated cabinet hinge 102A, described with reference to FIG. 4. The example refrigerated cabinet hinge 102B is illustrated in closed (FIGS. 5A and 5D), partly folded (FIGS. 5B and 5E), and opened configurations (FIGS. 5C and 5F). FIGS. 5A-5F illustrate that the hinge support 108B and the hinge bracket 110B are configured to fold on top of each other in a closed (FIGS. 5A and 5D) configuration. The hinge support 108B and the hinge bracket 110B can be provided as durable, non-oxidizable plates having a predetermined folded thickness (e.g., smaller than or approximately equal to a gap between the door frame 104B and the refrigerated cabinet body 106). In some implementations, the hinge support 108B and the hinge bracket 110B can vary in thickness according to a weight of the door 104.

Although implementations have been described with reference to a number of illustrative implementations thereof, it should be understood that numerous other modifications and implementations can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A refrigerated cabinet (top/bottom) hinge, the hinge includes: a hinge support mounted on the refrigerated cabinet, the hinge support including a planar portion in which one or more opened coupling holes are defined, a linkage mechanism including at least one pivot arm, the linkage mechanism including a proximal end and a distal end, the linkage mechanism being rotatably attached to the hinge support at the distal end, and a hinge bracket rotatably attached to the proximal end of the linkage mechanism, the linkage mechanism serving as a rotation shaft of a mounted door articulating out of the refrigerated cabinet, wherein the hinge support and the hinge bracket are configured to fold on top of each other in a closed configuration.

Example 2. The refrigerated cabinet hinge of the preceding example. wherein the mounted door includes a panel and a frame.

Example 3. The refrigerated cabinet hinge of any of the preceding examples, wherein the mounted door has a thickness of approximately 10 mm to 50 mm.

Example 4. The refrigerated cabinet hinge of any of the preceding examples, wherein the mounted door wraps around the refrigerated cabinet, when the refrigerated cabinet is closed, the door being flush fitted within an exterior housing of the refrigerated cabinet or adjacent cabinetry or other adjacent surfaces.

Example 5. The refrigerated cabinet hinge of any of the preceding examples, wherein the mounted door articulates out, when the mounted door is opened.

Example 6. The refrigerated cabinet hinge of any of the preceding examples, wherein the mounted door articulates around the refrigerated cabinet.

Example 7. The refrigerated cabinet hinge of any of the preceding examples, wherein the mounted door is flush fitted with the refrigerated cabinet, when the mounted door is closed.

Example 8. The refrigerated cabinet hinge of any of the preceding examples, wherein the at least one pivot arm includes a pair of articulating bars.

Example 9. The refrigerated cabinet hinge of any of the preceding examples, wherein the hinge bracket movement relative to the hinge support is limited to a stable configuration, wherein in the stable configuration the refrigerated cabinet is opened without a toppling risk.

Example 10. The refrigerated cabinet hinge of any of the preceding examples, wherein the at least one pivot arm includes a substantially flat surface.

Example 11. The refrigerated cabinet hinge of any of the preceding examples, wherein the hinge support is mounted on a surface of the refrigerated cabinet.

Example 12. The refrigerated cabinet hinge of any of the preceding examples, wherein the hinge support is at least partially embedded into the body of the refrigerated cabinet.

Example 13. The refrigerated cabinet hinge of any of the preceding examples, wherein the hinge includes Polyvinyl chloride (PVC), thermoplastic, aluminum, stainless steel, other suitable metals, metal alloys, or other synthetic polymer.

Example 14. A refrigerated cabinet (top) hinge, the hinge includes: a hinge support horizontally mounted on a surface of the refrigerated cabinet, the hinge support including a planar portion in which one or more opened coupling holes are defined, a linkage mechanism including at least one pivot arm, the linkage mechanism including a proximal end and a distal end, the linkage mechanism being configured to rotatably attach to the hinge support at the distal end, and a hinge bracket configured to rotatably attach to the proximal end of the linkage mechanism, the linkage mechanism serving as a rotation shaft of a mounted door articulating out of the refrigerated cabinet, wherein the hinge support and the hinge bracket are configured to fold on top of each other in a closed configuration.

Example 15. The refrigerated cabinet hinge of the preceding example, wherein the mounted door includes a panel and a frame.

Example 16. The refrigerated cabinet hinge of any of the preceding examples, wherein the mounted door has a thickness of approximately 10 mm to 50 mm.

Example 17. The refrigerated cabinet hinge of any of the preceding examples, wherein the mounted door wraps around the refrigerated cabinet, when the refrigerated cabinet is closed, the door being flush fitted within an exterior housing of the refrigerated cabinet.

Example 18. The refrigerated cabinet hinge of any of the preceding examples, wherein the mounted door articulates out, when the mounted door is opened.

Example 19. The refrigerated cabinet hinge of any of the preceding examples, wherein the mounted door articulates around the refrigerated cabinet.

Example 20. The refrigerated cabinet hinge of any of the preceding examples, wherein the mounted door is flush fitted with the refrigerated cabinet, when the mounted door is closed.

Example 21. The refrigerated cabinet hinge of any of the preceding examples, wherein the at least one pivot arm includes a pair of articulating bars.

Example 22. The refrigerated cabinet hinge of any of the preceding examples, wherein the hinge bracket movement relative to the hinge support is limited to a stable configuration, wherein in the stable configuration the refrigerated cabinet is opened without a toppling risk.

Example 23. The refrigerated cabinet hinge of any of the preceding examples, wherein at least one pivot arm includes a substantially flat surface.

Example 24. The refrigerated cabinet hinge of any of the preceding examples, wherein the hinge support is mounted on a surface of the refrigerated cabinet.

Example 25. The refrigerated cabinet hinge of any of the preceding examples, wherein the hinge support is at least partially embedded into the body of the refrigerated cabinet.

Example 26. The refrigerated cabinet hinge of any of the preceding examples, wherein the hinge includes Polyvinyl chloride (PVC), thermoplastic, aluminum, stainless steel, other suitable metals, metal alloys, or other synthetic polymer.

Example 27. A refrigerated cabinet (bottom) hinge, the hinge includes: a hinge support mounted on a bottom vertical edge of the refrigerated cabinet, the hinge support including a bent structure including a vertical portion and a horizontal portion, a linkage mechanism including at least one pivot arm, the linkage mechanism including a proximal end and a distal end, the linkage mechanism is configured to rotatably attach to the hinge support at the distal end, and a hinge bracket configured to rotatably attach to the proximal end of the linkage mechanism, the hinge bracket including a hinge pin that serves as a rotation shaft of a mounted door articulating out of the refrigerated cabinet, wherein the horizontal portion of the hinge support and the hinge bracket fold on top of each other in a closed configuration.

Example 28. The refrigerated cabinet hinge of the preceding examples wherein the mounted door includes a panel and a frame.

Example 29. The refrigerated cabinet hinge of any of the preceding examples, wherein the mounted door has a thickness of approximately 10 mm to 50 mm.

Example 30. The refrigerated cabinet hinge of any of the preceding examples, wherein the mounted door wraps around the refrigerated cabinet, when the refrigerated cabinet is closed, the door being flush fitted within an exterior housing of the refrigerated cabinet.

Example 31. The refrigerated cabinet hinge of any of the preceding examples, wherein the mounted door articulates out, when the mounted door is opened.

Example 32. The refrigerated cabinet hinge of any of the preceding examples, wherein the mounted door articulates around the refrigerated cabinet.

Example 33. The refrigerated cabinet hinge of any of the preceding examples, wherein the mounted door is flush fitted with the refrigerated cabinet, when the mounted door is closed.

Example 34. The refrigerated cabinet hinge of any of the preceding examples, wherein the at least one pivot arm includes a pair of articulating bars.

Example 35. The refrigerated cabinet hinge of any of the preceding examples, wherein the hinge bracket movement relative to the hinge support is limited to a stable configuration, wherein in the stable configuration the refrigerated cabinet is opened without a toppling risk.

Example 36. The refrigerated cabinet hinge of any of the preceding examples, wherein the at least one pivot arm includes a substantially flat surface.

Example 37. The refrigerated cabinet hinge of any of the preceding examples, wherein the hinge support is mounted on a surface of the refrigerated cabinet.

Example 38. The refrigerated cabinet hinge of any of the preceding examples, wherein the hinge support is at least partially embedded into the body of the refrigerated cabinet.

Example 39. The refrigerated cabinet hinge of any of the preceding examples, wherein the hinge includes Polyvinyl chloride (PVC), thermoplastic, aluminum, stainless steel, other suitable metals, metal alloys, or other synthetic polymer.

What is claimed is:

1. A refrigerated cabinet hinge, comprising:
a hinge support mounted on a refrigerated cabinet, the hinge support comprising a planar portion in which one or more opened coupling holes are defined;
a linkage mechanism comprising at least one pivot arm, the linkage mechanism comprising a proximal end and a distal end, the linkage mechanism configured to rotatably attach to the hinge support at the distal end; and
a hinge bracket configured to rotatably attach to the proximal end of the linkage mechanism, the linkage mechanism comprising a rotation shaft of a mounted door articulating out of the refrigerated cabinet, wherein the hinge support and the hinge bracket fold on top of each other in a closed configuration.

2. The refrigerated cabinet hinge of claim 1, wherein the mounted door comprises a panel and a frame.

3. The refrigerated cabinet hinge of claim 1, wherein the mounted door has a thickness of approximately 10 mm to 50 mm.

4. The refrigerated cabinet hinge of claim 1, wherein the mounted door wraps around the refrigerated cabinet, when the refrigerated cabinet is closed, the door being flush fitted within an exterior housing of the refrigerated cabinet or adjacent cabinetry or other adjacent surfaces.

5. The refrigerated cabinet hinge of claim 1, wherein the mounted door articulates out, when the mounted door is opened.

6. The refrigerated cabinet hinge of claim 5, wherein the mounted door articulates around the refrigerated cabinet.

7. The refrigerated cabinet hinge of claim 1, wherein the mounted door is flush fitted with the refrigerated cabinet, when the mounted door is closed.

8. The refrigerated cabinet hinge of claim 1, wherein the at least one pivot arm comprises a pair of articulating bars.

9. The refrigerated cabinet hinge of claim 1, wherein the hinge bracket movement relative to the hinge support is limited to a stable configuration, wherein in the stable configuration the refrigerated cabinet is opened without a toppling risk.

10. The refrigerated cabinet hinge of claim 1, wherein the at least one pivot arm comprises a substantially flat surface.

11. The refrigerated cabinet hinge of claim 1, wherein the hinge support is mounted on a surface of the refrigerated cabinet.

12. The refrigerated cabinet hinge of claim 1, wherein the hinge support is at least partially embedded into a body of the refrigerated cabinet.

13. The refrigerated cabinet hinge of claim 1, wherein the hinge comprises a metal or a plastic material.

14. A refrigerated cabinet hinge, comprising:
a hinge support horizontally mounted on a surface of a refrigerated cabinet, the hinge support comprising a planar portion in which one or more opened coupling holes are defined;
a linkage mechanism comprising at least one pivot arm, the linkage mechanism comprising a proximal end and a distal end, the linkage mechanism configured to rotatably attach to the hinge support at the distal end; and
a hinge bracket configured to rotatably attach to the proximal end of the linkage mechanism, the linkage mechanism comprising a rotation shaft of a mounted door articulating out of the refrigerated cabinet, wherein the hinge support and the hinge bracket fold on top of each other in a closed configuration.

15. The refrigerated cabinet hinge of claim 14, wherein the mounted door comprises a panel and a frame, and wherein the mounted door has a thickness of approximately 10 mm to 50 mm.

16. The refrigerated cabinet hinge of claim 14, wherein the mounted door wraps around the refrigerated cabinet, when the refrigerated cabinet is closed, the door being flush fitted within an exterior housing of the refrigerated cabinet.

17. The refrigerated cabinet hinge of claim 1, wherein the mounted door articulates out, when the mounted door is opened.

18. A refrigerated cabinet hinge, comprising:
a hinge support mounted on a bottom vertical edge of a refrigerated cabinet, the hinge support comprising a structure comprising a vertical portion and a horizontal portion;
a linkage mechanism comprising at least one pivot arm, the linkage mechanism comprising a proximal end and a distal end, the linkage mechanism configured to rotatably attach to the hinge support at the distal end; and
a hinge bracket configured to rotatably attach to the proximal end of the linkage mechanism, the hinge bracket comprising a hinge pin that serves as a rotation shaft of a mounted door articulating out of the refrigerated cabinet, wherein the horizontal portion of the hinge support and the hinge bracket are configured to fold on top of each other in a closed configuration.

19. The refrigerated cabinet hinge of claim 18, wherein the mounted door comprises a panel and a frame, and wherein the mounted door has a thickness of approximately 10 mm to 50 mm.

20. A refrigerated cabinet, comprising:
a housing; and
a cabinet hinge, comprising:
a hinge support mounted on the refrigerated cabinet, the hinge support comprising a planar portion in which one or more opened coupling holes are defined;
a linkage mechanism comprising at least one pivot arm, the linkage mechanism comprising a proximal end and a distal end, the linkage mechanism configured to rotatably attach to the hinge support at the distal end; and
a hinge bracket configured to rotatably attach to the proximal end of the linkage mechanism, the linkage mechanism comprising a rotation shaft of a mounted door articulating out of the refrigerated cabinet, wherein the hinge support and the hinge bracket fold on top of each other in a closed configuration.
